(19) United States
(12) Patent Application Publication
(10) Pub. No.: US 2013/0022268 A1
(43) Pub. Date: Jan. 24, 2013

(54) IMAGE PROCESSING APPARATUS, IMAGE PROCESSING SYSTEM, AND IMAGE PROCESSING PROGRAM

(71) Applicant: Koichiro Kishima, Kanagawa (JP)

(72) Inventor: Koichiro Kishima, Kanagawa (JP)

(73) Assignee: SONY CORPORATION, Tokyo (JP)

(21) Appl. No.: 13/546,750

(22) Filed: Jul. 11, 2012

(30) Foreign Application Priority Data
Jul. 19, 2011 (JP) 2011-157980

(51) Int. Cl. G06K 9/34

(52) U.S. Cl. 382/173

(57) ABSTRACT

An image processing apparatus includes an image obtaining unit configured to obtain a scan image, a tile area setting unit configured to section the scan image into a plurality of tile areas, a temporary tile area setting unit configured to set a temporary tile area in the scan image, the temporary tile area including the tile area and being larger than the tile area, a temporary tile image generation unit configured to extract the scan image for each temporary tile area to generate a temporary tile image, a noise removal unit configured to perform a noise removal process with respect to the temporary tile image, and a tile image generation unit configured to extract the temporary tile image for each tile area to generate a tile image.

### CROSS REFERENCES TO RELATED APPLICATIONS

The present application claims priority to Japanese Priority Patent Application JP 2011-157980 filed in the Japan Patent Office on Jul. 19, 2011, the entire content of which is hereby incorporated by reference.

### BACKGROUND

The present disclosure relates to an image processing apparatus, an image processing system, and an image processing program relating to a tile division process of a scan image taken through a microscope in a pathological diagnosis.

In the field of a pathological diagnosis or the like, a process called tiling (tile division) for processing a microscope image with a high resolution is often carried out. When an image of an object to be observed is taken at a high resolution (high power), an image taking area in a single-time image taking is small, but images of different areas of the object to be observed are sequentially taken, and a plurality of images (scan images) taken are coupled (stitched) with each other, thereby making it possible to obtain one large image with a high resolution.

The tiling is a process of dividing a scan image of an object to be observed into tiles having a predetermined size (256 pixels×256 pixels, for example) to store the tiles in an HDD (hard disk drive) or the like. As a result, it is possible to release a memory in which the scan image is read and obtain the next scan image. For example, Japanese Patent Application Laid-open No. 2009-37250 (paragraph 0036, FIG. 16) discloses that an image obtained by scanning is tiled.

### SUMMARY

In a microscope image, in particular, a fluorescence microscope image taken with the use of a fluorescence microscope, a noise in an image is removed by a mathematical operation (wevelet transform or the like) in general. However, in the case where the noise removal process is carried out with respect to the scan image, there arises a problem in that a phenomenon which occurs due to the tiling makes it difficult to generate a microscope image at high speed with high accuracy.

In view of the above-mentioned circumstances, it is desirable to provide an image processing apparatus, an image processing system, and an image processing program which are capable of generating a microscope image at high speed with high accuracy.

According to an embodiment of the present disclosure, there is provided an image processing apparatus including an image obtaining unit, a tile area setting unit, a temporary tile area setting unit, a temporary tile image generation unit, a noise removal unit, and a tile image generation unit.

The image obtaining unit is configured to obtain a scan image.

The tile area setting unit is configured to section the scan image into a plurality of tile areas.

The temporary tile area setting unit is configured to set a temporary tile area in the scan image, and the temporary tile area includes the tile area and is larger than the tile area.

The temporary tile image generation unit is configured to extract the scan image for each temporary tile area to generate a temporary tile image.

The noise removal unit is configured to perform a noise removal process with respect to the temporary tile image.

The tile image generation unit is configured to extract the temporary tile image for each tile area to generate a tile image.

With this structure, at the time when the temporary tile image generation unit generates the temporary tile image, a memory of the image processing apparatus is released, and the next scan image can be obtained. The noise removal process is not carried out until the temporary tile image is generated, so it is possible to quickly release the memory. Therefore, in the image processing apparatus, the image obtaining unit can obtain the next scan image quickly. Further, when the noise removal unit carries out the noise removal process with respect to the temporary tile image, on the edge of the temporary tile image, a “discontinuous area” is generated due to a loss of information of continuous pixels. In contrast, the tile image generation unit sets a tile area of the temporary tile image which has been subjected to the noise removal process as a tile image, thereby preventing the discontinuous area from being generated in the tile image. As a result, in the image processing apparatus, when the tile images are arranged and displayed, it is possible to prevent the image on a boundary between adjacent tile images from being discontinuous.

The image obtaining unit may obtain a plurality of continuous scan images, the image processing apparatus may further include a stitching unit configured to calculate relative positions of the plurality of scan images, and the tile area setting unit may section the scan image into a plurality of tile areas on the basis of the relative positions.

With this structure, when setting the tile area with respect to a specific scan image, the tile area setting unit can set the tile area astride continuous scan images. Therefore, the temporary image generation unit can generate the temporary tile image by also using the continuous scan images. As a result, even in the case where a plurality of scan images are taken with respect to one object to be observed, it is possible to generate the tile images continuous between the plurality of scan images.

The scan image may be a fluorescence microscope image taken through a fluorescence microscope.

The fluorescence microscope image has small brightness of the object to be observed in principle thereof, and therefore it is necessary to perform exposure by an image pickup element for a long time period. Thus, a noise is likely to be generated in the fluorescence microscope image. The noise removal process by the image processing apparatus according to the present disclosure is particularly effective.

According to another embodiment of the present disclosure, there is provided an image processing system including an image pickup apparatus and an image processing apparatus.

The image pickup apparatus is configured to take a scan image of an object to be observed.

The image processing apparatus includes an image obtaining unit configured to obtain the scan image, a tile area setting unit configured to section the scan image into a plurality of tile areas, a temporary tile area setting unit configured to set a temporary tile area in the scan image, the temporary tile area including the tile area and being larger than the tile area, a temporary tile image generation unit configured to extract the scan image for each temporary tile area to generate a temporary tile image, a noise removal unit configured to perform a noise removal process with respect to the temporary tile image, and a tile image generation unit configured to extract the temporary tile image for each tile area to generate a tile image.

The image pickup apparatus may take an image of the object to be observed through a fluorescence microscope.

According to another embodiment of the present disclosure, there is provided an image processing program causing a computer to function as an image obtaining unit, a tile area setting unit, a temporary tile area setting unit, a temporary tile image generation unit, a noise removal unit, and a tile image generation unit.

The image obtaining unit is configured to obtain a scan image.

The tile area setting unit is configured to section the scan image into a plurality of tile areas.

The temporary tile area setting unit is configured to set a temporary tile area in the scan image, and the temporary tile area includes the tile area and is larger than the tile area.

The temporary tile image generation unit is configured to extract the scan image for each temporary tile area to generate a temporary tile image.

The noise removal unit is configured to perform a noise removal process with respect to the temporary tile image.

The tile image generation unit is configured to extract the temporary tile image for each tile area to generate a tile image.

As described above, according to the present disclosure, it is possible to provide the image processing apparatus, the image processing system, and the image processing system which are capable of generating a microscope image at high speed with high accuracy.

Additional features and advantages are described herein, and will be apparent from the following Detailed Description and the figures.

### BRIEF DESCRIPTION OF THE FIGURES

FIG. 1 is a block diagram showing a functional structure of an image processing system according to an embodiment of the present disclosure;

FIG. 2 is a conceptual diagram for explaining an image pickup of an image pickup target by an image pickup apparatus that constitutes the image processing system;

FIGS. 3A to 3C are diagrams each showing an example of a scan image obtained by an image obtaining unit of an image processing apparatus that constitutes the image processing system;

FIGS. 4A and 4B are conceptual diagrams each showing stitching by a stitching unit of the image processing apparatus that constitutes the image processing system;

FIGS. 5A and 5B are conceptual diagrams each showing tile areas which are set in the scan image by a tile area setting unit of the image processing apparatus that constitutes the image processing system;

FIGS. 6A and 6B are conceptual diagrams each showing temporary tile areas set in the scan image by a temporary tile area setting unit of the image processing apparatus that constitutes the image processing system;

FIG. 7 is a conceptual diagram showing temporary tile images generated by a temporary tile image generation unit of the image processing apparatus that constitutes the image processing system;

FIGS. 8A and 8B are conceptual diagrams each showing a noise removal by a noise removal unit of the image processing apparatus that constitutes the image processing system;

FIGS. 9A and 9B are conceptual diagrams each showing a tile image generated by a tile image generation unit of the image processing apparatus that constitutes the image processing system;

FIG. 10 is a diagram showing arranged tile images displayed by a display unit of the image processing apparatus that constitutes the image processing system;

FIGS. 11A to 11D are conceptual diagrams for explaining a noise removal method according to a comparative example 1;

FIGS. 12A to 12D are conceptual diagrams for explaining a noise removal method according to a comparative example 2;

FIG. 13 is a schematic diagram showing a fluorescence microscope as a specific example of the image pickup apparatus that constitutes the image processing system according to the embodiment of the present disclosure;

FIG. 14 is a schematic diagram showing a microscope computer as a specific example of the image processing apparatus that constitutes the image processing system;

FIGS. 15A to 15C are diagrams each showing an image showing an effect of the image processing system;

FIGS. 16A and 16B are diagrams each showing a graph of a brightness distribution of the image showing the effect of the image processing system;

FIGS. 17A and 17B are diagrams each showing a graph of a brightness distribution of the image showing the effect of the image processing system; and

FIGS. 18A and 18B are diagrams each showing a graph of a brightness distribution of the image showing the effect of the image processing system.

### DETAILED DESCRIPTION

Hereinafter, an embodiment of the present disclosure will be described with reference to the drawings.

<Functional Structure of Image Processing System>

A functional structure of an image processing system according to this embodiment will be described.

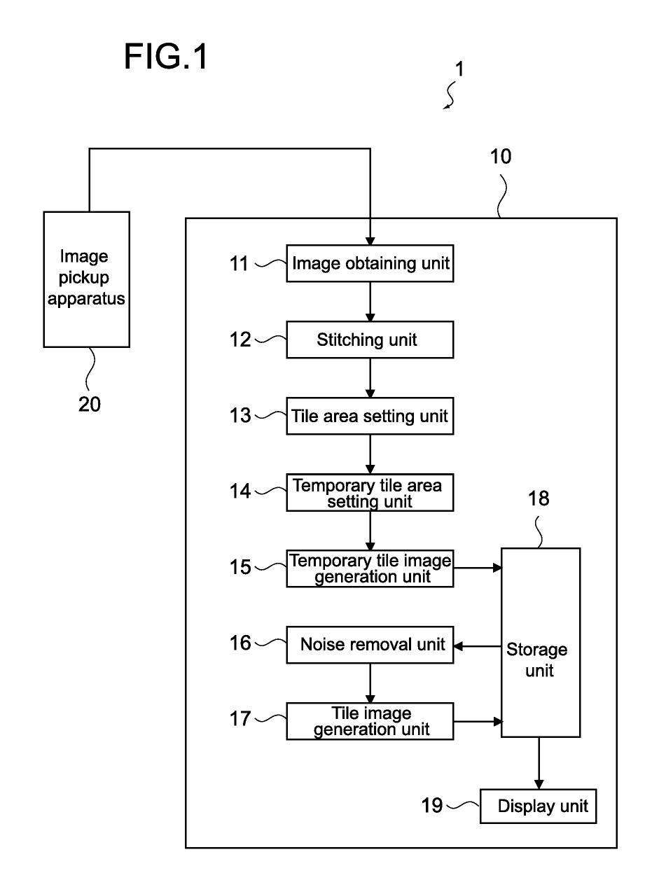

FIG. 1 is a block diagram showing the functional structure of an image processing system 1 according to an embodiment of the present disclosure. As shown in the figure, the image processing system 1 is constituted of an image processing apparatus 10 and an image pickup apparatus 20, and the image pickup apparatus 20 is connected to the image processing apparatus 10. It should be noted that the image processing apparatus 10 is, for example, a computer for a microscope, and the image pickup apparatus 20 is, for example, a fluorescence microscope image pickup apparatus.

The image processing apparatus 10 includes an image obtaining unit 11, a stitching unit 12, a tile area setting unit 13, a temporary tile area setting unit 14, a temporary tile image generation unit 15, a noise removal unit 16, a tile image generation unit 17, a storage unit 18, and a display unit 19. The image obtaining unit 11, the stitching unit 12, the tile area setting unit 13, the temporary tile area setting unit 14, and the temporary tile image generation unit 15 are sequentially connected in the stated order, and the temporary tile image generation unit 15, the storage unit 18, the noise removal unit 16, the tile image generation unit 17, and the storage unit 18 are sequentially connected in the stated order. The display unit 19 is connected with the storage unit 18.

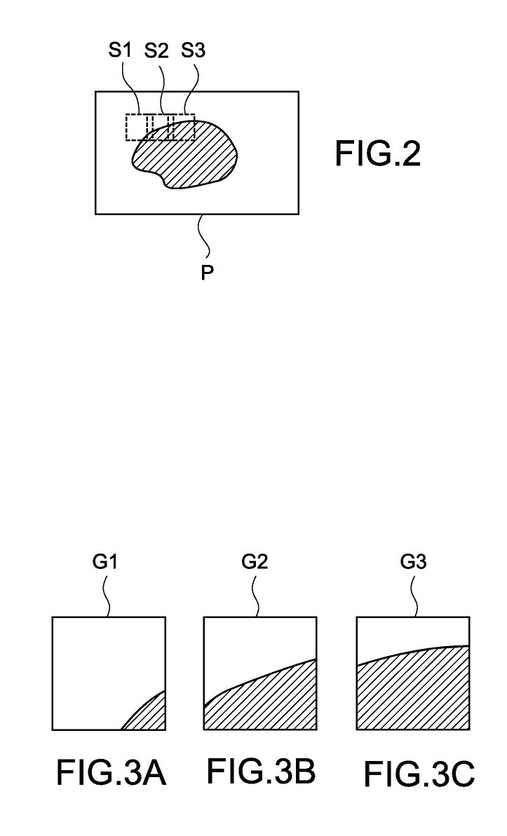

The image pickup apparatus 20 takes a scan image of an object, an image of which is to be taken (hereinafter, referred to as image pickup target). FIG. 2 is a conceptual diagram for explaining an image pickup of an image pickup target P by the image pickup apparatus 20. As shown in the figure, an image pickup range S1, an image of which is taken in one shot by the image pickup apparatus 20, an image pickup range S2, an image of which is taken in a subsequent shot, and an image pickup range S3, an image of which is taken in a subsequent shot are shown on the image pickup target P.

In the case where the image pickup apparatus 20 is a microscope image pickup apparatus, although the image pickup range in one shot differs depending on a magnification, the image pickup range does not cover the entire image pickup target P and therefore may generally be a partial area of the image pickup target P. Thus, to take a high-power image of the entire image pickup target P, it is necessary to take images while shifting the image pickup range. It should be noted that the image pickup range can be determined through an area detection process from a thumbnail image obtained by taking an image of the entire image pickup target P at a low power.

Hereinafter, an image taken in one-shot image taking by the image pickup apparatus 20 is referred to as a “scan image”. The number of pixels of the scan image is the number of pixels of an image pickup element of the image pickup apparatus 20 and may be set to 24 M pixels (24,000,000 pixels). The image pickup apparatus 20 outputs the scan images to the image obtaining unit 11 of the image processing apparatus 10 sequentially for each image taking.

The image obtaining unit 11 obtains the scan images output from the image pickup apparatus 20 as described above. FIG. 3 are diagrams each showing an example of the scan image obtained by the image obtaining unit 11. FIG. 3A shows a scan image G1 taken in the image pickup range S1, FIG. 3B shows a scan image G2 taken in the image pickup range S2, and FIG. 3C shows a scan image G3 taken in the image pickup range S3. The image obtaining unit 11 supplies the scan images to the stitching unit 12 sequentially.

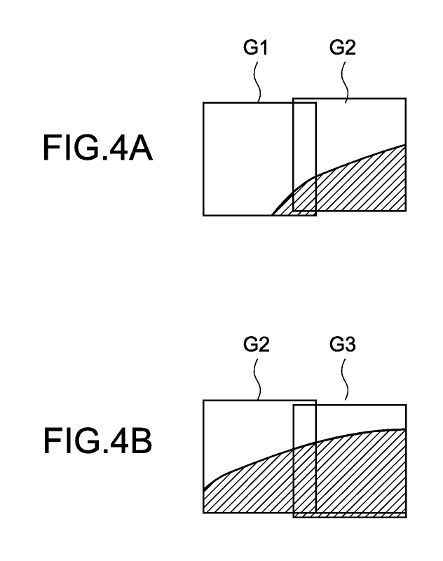

The stitching unit 12 performs “stitching” of the scan images supplied from the image obtaining unit 11. FIG. 4 are conceptual diagrams each showing the stitching. As shown in the figures, the stitching refers to calculating relative positions of the scan images taken at different times. The stitching unit 12 can calculate the relative positions of the scan images with the use of a correlation coefficient or the like of a brightness value of each pixel of the scan images, for example.

As shown in FIG. 4A, the stitching unit 12 calculates a position of the scan image G2 relative to the scan image G1 at a time when the scan image G1 and the scan image G2 are supplied from the image obtaining unit 11. Then, as shown in FIG. 4B, the stitching unit 12 calculates a position of the scan image G3 relative to the scan image G2 at a time when the scan image G3 is supplied. Thus, the stitching unit 12 can calculate the relative position of the scan image G3 from the scan image G1.

It should be noted that the stitching unit 12 does not generate an image obtained by coupling the scan images actually but calculates the relative positions (offset value, for example) of the scan images with respect to each other. The stitching unit 12 supplies the relative positions calculated to the tile area setting unit 13. It should be noted that in the following description, one of the scan images G1 to G3 is simply referred to as a scan image G.

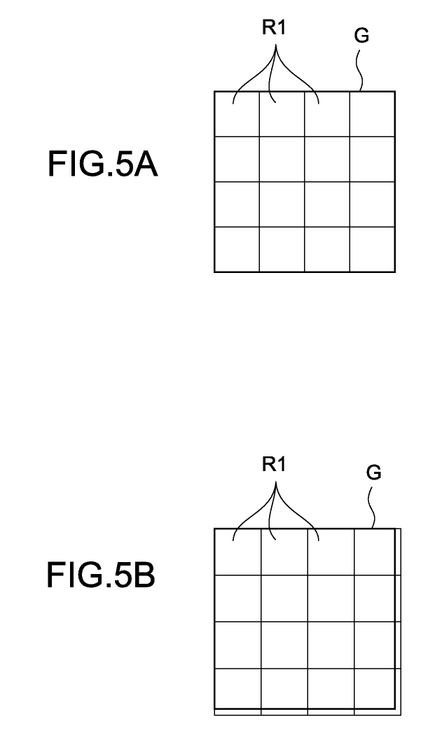

The tile area setting unit 13 sections the scan image G into a plurality of “tile areas”. FIG. 5 are conceptual diagrams each showing tile areas R1 which are set in the scan image G. The tile area R1 is an area as a division unit at a time when the tile image generation unit 17 to be described later divides the scan image G to generate “tile images”. The tile area R1 can have any size but desirably has 256 pixels×256 pixels for convenience of a content of the image or a computation process.

The tile areas R1 shown in FIG. 5A coincide with a perimeter of the scan image G, but the case may occur in which the tile areas R1 lie off the perimeter of the scan image G as shown in FIG. 5B. In this case, the tile image generation unit 17 uses a part of another scan image on the basis of the relative positions calculated by the stitching unit 12, so there is no problem. The tile area setting unit 13 supplies the tile areas R1 to the temporary tile area setting unit 14 along with the scan image G.

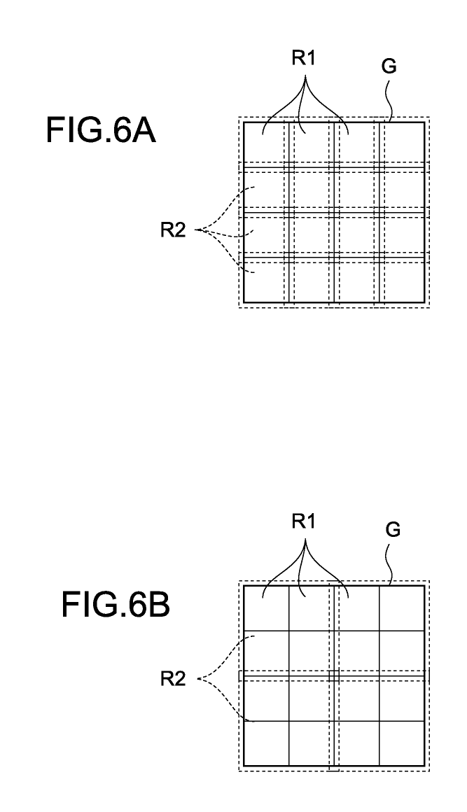

The temporary tile area setting unit 14 sets a “temporary tile area” on the scan image. FIG. 6 are conceptual diagrams each showing temporary tile areas R2 set in the scan image G. The temporary tile area R2 can be set as an area which includes at least one tile area R1 and is larger than the tile area R1.

As shown in FIG. 6A, the temporary tile area R2 can be an area larger than each tile area R1 by a predetermined width. Specifically, in the case where the size of the tile area R1 is 256 pixels×256 pixels, the size of the temporary tile area R2 can set to 288 pixels×288 pixels (that is, the predetermined width is 16 pixels). The predetermined width is not particularly limited thereto. However, to reduce a load on a computation process in a noise removal to be described later, the pixel is desirably set to multiples of 8. Further, as shown in FIG. 6B, the temporary tile area R2 can also be an area larger than a plurality of (four or nine, for example) adjacent tile areas R1 by a predetermined width.

As described above, the tile areas R1 are the areas obtained by sectioning the scan image G, and therefore each of the tile areas R1 is not overlapped with an adjacent tile area R1. However, the temporary tile area R2 is larger than the tile area R1 by the predetermined width and is therefore overlapped with an adjacent temporary tile area R2. The temporary tile area setting unit 14 supplies the temporary tile areas R2 to the temporary tile image generation unit 15 along with the tile areas R1 and the scan image G.

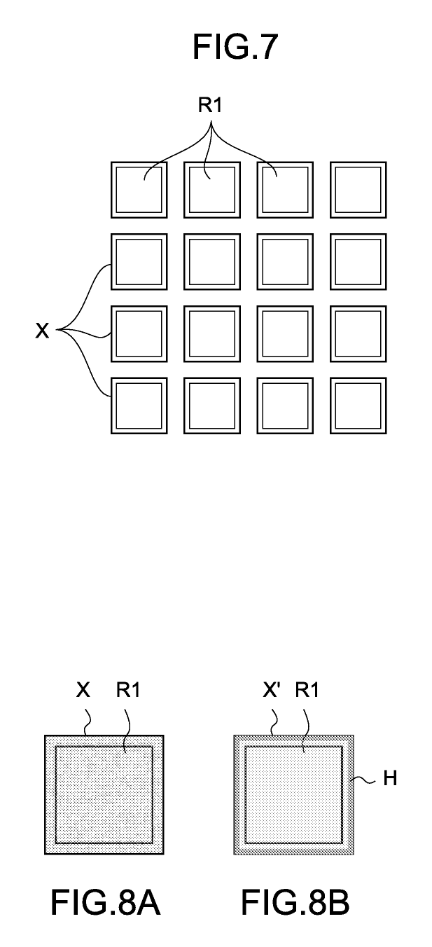

The temporary tile image generation unit 15 generates “temporary tile images” from the scan image G. FIG. 7 is a conceptual diagram showing temporary tile images X. As shown in the figure, the temporary tile image generation unit 15 extracts the scan image for each temporary tile area R2 in the scan image G to generate the temporary tile images X. As described above, the temporary tile area R2 is overlapped with the adjacent temporary tile area R2, so an image area included in the two or more temporary tile areas R2 is included in each of the tile images X.

It should be noted that, in the case where the temporary tile image generation unit 15 operates as follows in the case where the tile area R1 (and temporary tile area R2) set by the tile area setting unit 13 lies off the scan image G (see, FIG. 5B). Specifically, on the basis of the relative position of the scan images G calculated by the stitching unit 12, the temporary tile image generation unit 15 extracts an image area which should be included in the temporary tile area R2 from the adjacent scan images G to generate the temporary tile image X. The temporary tile image generation unit 15 supplies the temporary tile image X generated to the storage unit 18.

The storage unit 18 stores the temporary tile image X supplied from the temporary tile image generation unit 15. At this time, a memory used for the process by the temporary tile image generation unit 15 is released from the image obtaining unit 11. That is, the temporary tile image generation unit 15 can execute the above-mentioned process with respect to a new scan image.

The noise removal unit 16 reads the temporary tile images X stored in the storage unit 18 and carries out the noise removal process. The noise can be removed by various algorisms such as the wavelet transform and a high frequency component cutting. Specifically, a wavelet toolbox (registered trademark: MathWorks, Inc) of an extension package of MATLAB (registered trademark: MathWorks, Inc) can be used to remove the noise. FIG. 8 are conceptual diagrams for explaining the noise removal by the noise removal unit 16. FIG. 8A shows one of the temporary tile images X before the noise removal, and FIG. 8B shows the temporary tile image X after the noise removal (hereinafter, referred to as temporary tile image X′).

In the temporary tile image X shown in FIG. 8A, noise components exist in the entire image. In contrast, when the noise removal process is carried out, the noise components are removed as shown in FIG. 8B. But, in an edge portion of the temporary tile image X′, a “discontinuous area” H is generated. The discontinuous area H is caused because the image is broken in the edge of the temporary tile image X at the time of the noise removal process. The detail will be explained in comparison with a comparative example 2 to be described later. The noise removal unit 16 carries out the noise removal process for all the temporary tile images X and supplies the temporary tile images X′ generated to the storage unit 18 again to be stored therein.

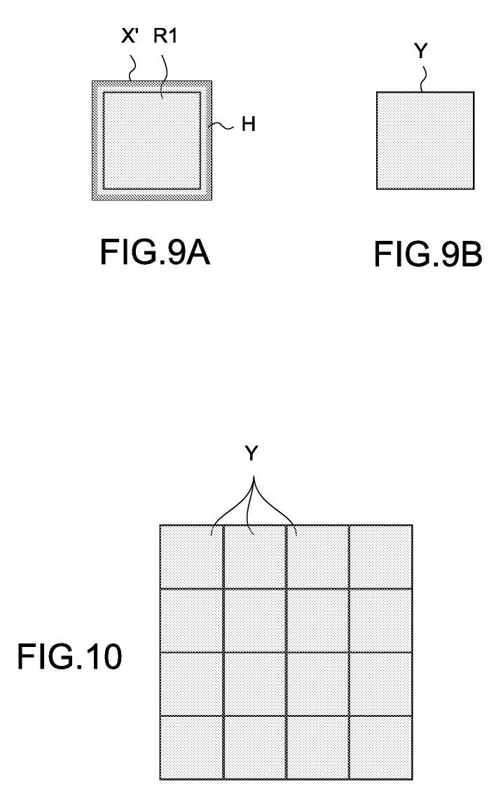

The tile image generation unit 17 reads the temporary tile image X′ which has been subjected to the noise removal and is stored in the storage unit 18, to generate a “tile image”. FIG. 9 are conceptual diagrams for explaining the generation of the tile image by the tile image generation unit 17. FIG. 9A shows the temporary tile image X′, and FIG. 9B shows a tile image Y which is generated by the tile image generation unit 17. The tile image generation unit 17 extracts the tile area R1 from the temporary tile image X′ (that is, a part except the tile area R1 is removed) to obtain the tile image Y. The discontinuous area H which exists in the temporary tile image X′ is not included in the tile area R1 (such setting is made for tile area R1) and therefore is not included in the tile image Y. The tile image generation unit 17 generates the tile image Y for each of the temporary tile images X′ and supplies the images to the storage unit 18 to be stored therein.

Through the operations from the image obtaining unit 11 to the tile image generation unit 17, the tile images Y generated from the scan images are stored in the storage unit 18. In accordance with an instruction by a user, the display unit 19 is capable of reading the tile images Y from the tile image generation unit 17 and displaying the images on a display or the like. FIG. 10 is a diagram showing an image (tile images Y arranged) displayed by the display unit 19.

As described above, the tile images Y are generated from the scan image G. The temporary tile image generation unit 15 divides the scan image G into the temporary tile images X and stores the images in the storage unit 18. At this time, it is possible to release the memory. Thus, the image obtaining unit 11 can quickly obtain the next scan image G.

Further, as described above, the temporary tile area setting unit 14 sets the temporary tile area R2 including the tile area R1, and the tile image generation unit 17 extracts only the tile area R1 from the temporary tile image X′ to generate the tile image Y. As a result, the discontinuous area H which is generated due to the noise removal process is not included in the tile area R1. Therefore, it is possible to exclude the discontinuous area from a display image at the time when the display unit 19 arranges and displays the tile images Y.

<Comparison with Other Noise Removal Processes>

### COMPARATIVE EXAMPLE 1

### Case where Noise is Removed before Scan Image is Tiled

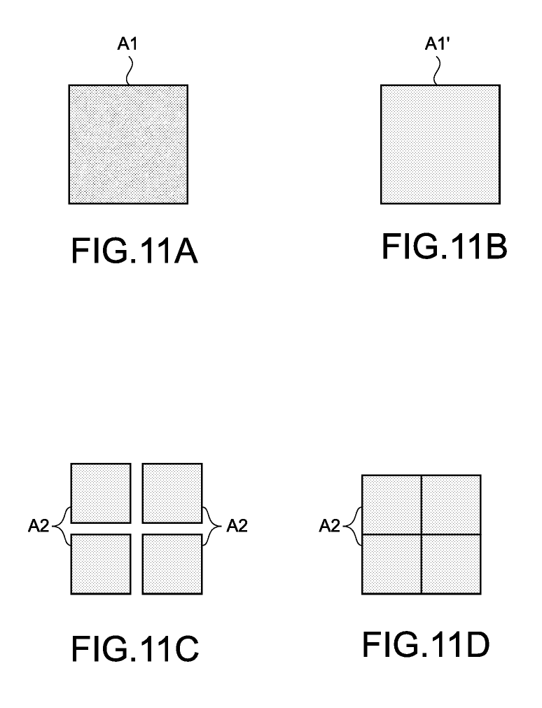

As a comparison, the case is studied in which the noise removal process is carried out for the scan image before the scan image is divided into the tile images. FIG. 11 are diagrams each conceptually explaining a noise removal method according to a comparative example 1.

FIG. 11A shows a scan image A1. In this comparison example, the noise removal process is executed with respect to the scan image A1, a scan image A1′ shown in FIG. 11B is generated, and the scan image A1′ is divided, to generate tile images A2 shown in FIG. 11C. Ultimately, an image (tile images A2 arranged) shown in FIG. 11D is a display image.

In this case, the scan image A1 generally has a large image size (large number of pixels), so the speed of the noise removal process becomes extremely slow. Therefore, a significantly long period of time is necessary for the generation of the scan image A1′ from the scan image A1. Because the memory can be released only after the scan image A1′ is divided into the tile images A2, and the tile images A2 are stored in an HDD or the like, it may be impossible for the image pickup apparatus to take, immediately after taking one scan image, the next scan image, with the result that a significantly long period of time is necessary to take images of the entire object to be observed.

### COMPARATIVE EXAMPLE 2

### Case where Noise is Removed after Scan Image is Tiled

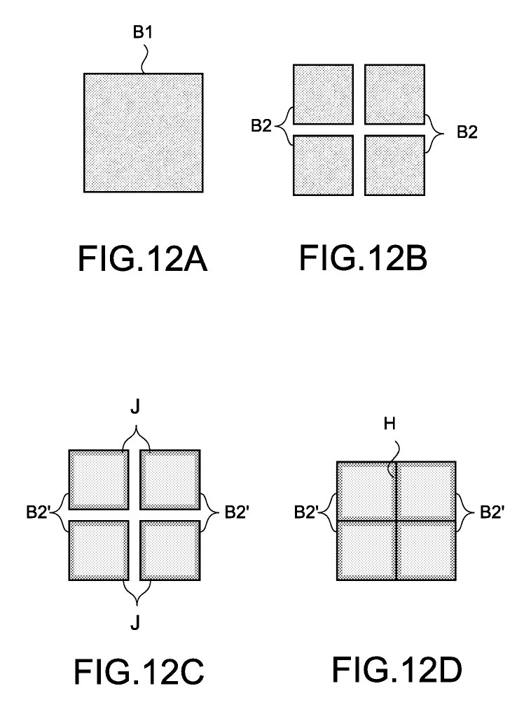

Further, as a comparison, the case is studied in which after the scan image is divided into the tile images, the noise removal process is carried out with respect to the tile images. FIG. 12 are diagrams for conceptually explaining a noise removal method according to the comparative example 2.

FIG. 12A shows a scan image B1. In this comparison example, the scan image B1 is divided to generate tile images B2 shown in FIG. 12B, and the tile images B2 are subjected to the noise removal process to generate tile images B2′ shown in FIG. 12C. Ultimately, an image (tile images B2′ arranged) shown in FIG. 12D is a display image.

In this case, the scan image B1 is divided into the tile images B2 without being subjected to the noise removal process, so it takes no time to generate the tile images B2. Therefore, the tile images B2 are stored, and the memory is released, thereby making it possible to cause the image pickup apparatus to take one scan image and, immediately after that, take the next scan image.

In this method, however, there arises a problem of the “discontinuous area”. When carrying out the noise removal process with respect to the tile images B2 as described above, the image is broken in the edge of each of the tile images B2, resulting in a loss of information (brightness value and the like) of pixels adjacent to each other. Thus, in each of the edges of the tile images B2′, an area (discontinuous area J) having no continuity with the adjacent tile images B2′ is generated. That is, as shown in FIG. 12D, in the image displayed on the display unit, the discontinuous area J exists on boundaries between the tile images B2′.

The discontinuous area J prevents a user from observing the display image. Further, in a pathological diagnosis, such an image is often subjected to an image process (such as a bright spot counting process in a fluorescent image), but this process may cause an erroneous detection or the like.

### Comparison between Image Processing System according to this Embodiment and Comparative Examples 1 and 2

In comparison with the comparative example 1, in the image processing system 1, before carrying out the noise removal process, the temporary tile image generation unit 15 generates the temporary tile images X from the scan image G and causes the storage unit 18 to store the images generated. Therefore, unlike the comparative example 1, the image processing system 1 does not have the problem of a delay of taking the scan image due to a long period of time necessary until the tile division (when the memory is released).

In comparison with the comparative example 2, in the image processing apparatus 10, the tile image generation unit 17 sets only the tile area R1 of the temporary tile image X′ in which the discontinuous area H does not exist to be the tile image Y. Therefore, unlike the comparative example 2, in the tile image Y (which is an ultimate display image), the discontinuous area H is not included, so it is possible to generate the display image which is free from an influence of the discontinuous area H.

<About Scan Image>

The scan image to be processed by the image processing system 1 according to this embodiment is not particularly limited as long as the scan image is a microscope image, but a fluorescence microscope image taken by the fluorescence microscope is particularly effective. The fluorescence microscope is a microscope that causes an object to be observed which is stained by a specific stain to be irradiated with excitation light and takes the fluorescence radiated from the object to be observed.

In the fluorescence microscope, the brightness of the object to be observed is smaller as compared to a typical microscope (bright field microscope) which uses visible light as a target, and therefore it is necessary to perform light exposure by an image pickup element for a long time. This causes a noise to be easily generated in the fluorescence microscope image, so the noise removal process is carried out with respect to the fluorescence microscope image in general in the field of the pathological diagnosis in which the fluorescence image is used. Thus, the image processing system 1 according to this embodiment is effective particularly for the fluorescence microscope image.

<Specific Structure of Image Processing System>

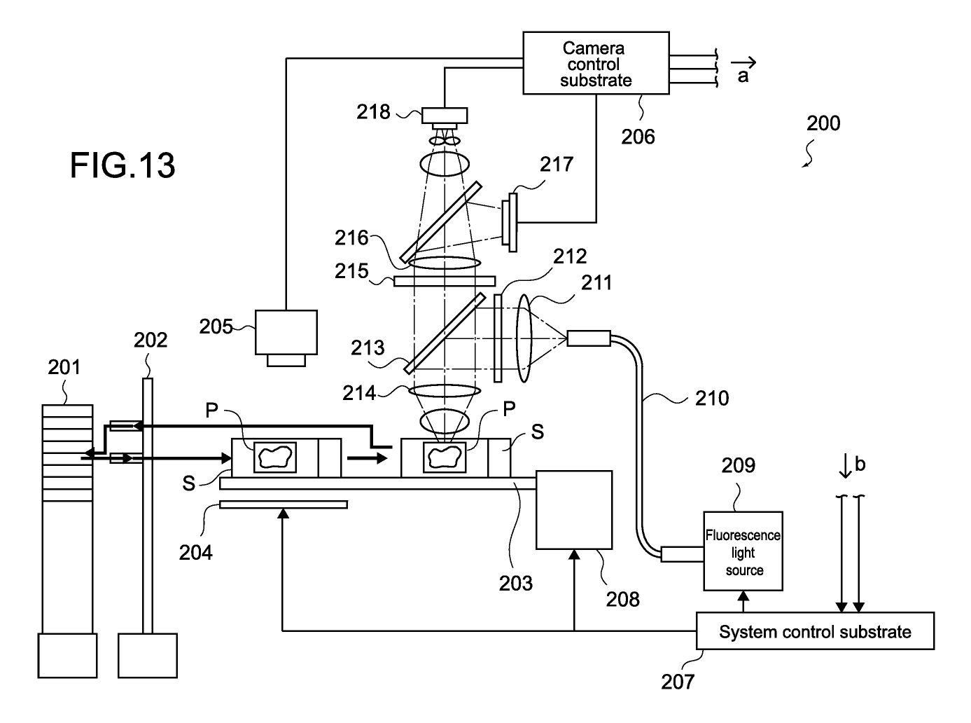

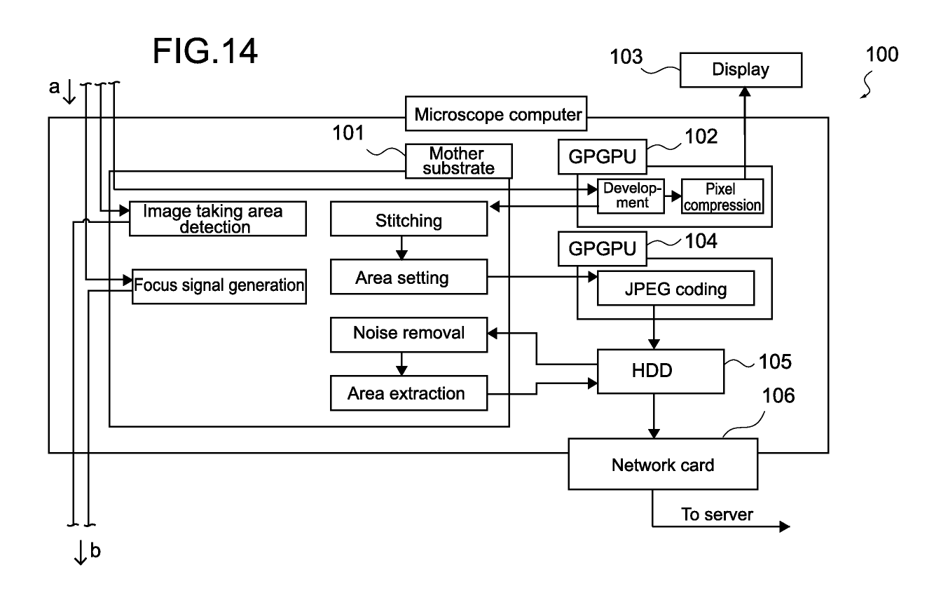

A description will be given on the specific structure of the image processing system 1 according to this embodiment of the present disclosure. FIG. 13 is a diagram showing a fluorescence microscope 200 as an example of the image pickup apparatus 20 of the image processing system 1, and FIG. 14 is a diagram showing a microscope computer 100 as an example of the image processing apparatus 10 of the image processing system 1.

As shown in FIG. 13, a glass slide stock 201 has a plurality of glass slides S on which an object to be observed (hereinafter, referred to as observation target) P is placed. A conveyance robot 202 takes out one glass slide S from the glass slide stock 201 and places the glass slide S on a stage 203.

An image of the glass slide S is taken by a macro image pickup camera 205 in the state where the glass slide S is irradiated by a macro image lighting 204 on the stage 203. The macro image pickup camera 205 outputs a macro image taken to a camera control substrate 206. The camera control substrate 206 supplies the macro image to a mother substrate 101 of the microscope computer 100.

The mother substrate 101 performs an image taking area detection process with respect to the macro image of the glass slide S and selects an area, an image of which is taken by the microscope. The mother substrate 101 supplies information of the area selected (hereinafter, referred to as area information) to a system control substrate 207.

The glass slide S is conveyed to an image taking range of the microscope by the stage 203. The system control substrate 207 controls a stage control unit 208 on the basis of the area information and makes a fine adjustment of the stage 203 so that the observation target P on the glass slide S is in the image taking range of the microscope.

The system control substrate 207 controls a fluorescence light source 209 to cause fluorescent illumination light to be emitted. The fluorescent illumination light passes through an exciter filter 212 via a light guide 210 and a fluorescent illumination light optical system 211 to become excitation light. The excitation light is reflected by a dichroic mirror 213 and collected by an objective lens 214 to be emitted on the observation target P. On the observation target P, the incident excitation light generates fluorescence.

The fluorescence generated on the observation target P is expanded by the objective lens 214 to be caused to travel in the dichroic mirror 213 in a straight line. Light having a wavelength other than the fluorescence is removed by an emission filter 215, light obtained passes through an imaging lens 216, and an image thereof is taken by an image pickup element 217 (CMOS (Complementary Metal Oxide Semiconductor) or the like). The fluorescence image (scan image) taken by the image pickup element 217 is output to the camera control substrate 206.

Further, before the image taking, a phase difference detection unit 218 may detect a phase difference of the fluorescence to supply the phase difference to the mother substrate 101 of the microscope computer 100. The mother substrate 101 generates a focus signal for defining a focal depth from the phase difference of the fluorescence, and the signal can be reflected on stage control by the stage control unit 208 through the system control substrate 207.

The scan image taken by the image pickup element 217 is supplied to a GPGPU (General-purpose computing on graphics processing unit) 102 of the microscope computer 100 as shown in FIG. 14.

The GPGPU 102 develops a scan image G (image obtaining unit 11) and supplies the image developed to the mother substrate 101. Further, the GPGPU 102 may perform a pixel compression of the scan image G and display the scan image on a display 103. The mother substrate 101 performs the stitching of the scan image G (stitching unit 12), and sets the tile area R1 and the temporary tile area R2 (tile area setting unit 13 and temporary tile area setting unit 14). The mother substrate 101 supplies, to a GPGPU 104, the scan image G in which the tile area R1 and the temporary tile area R2 are set.

The GPGPU 104 performs JPEG coding with respect to the scan image G to generate the temporary tile image X (temporary tile image generation unit 15) and stores the image in an HDD 105 (storage unit 18). The mother substrate 101 reads the temporary tile image X stored in the HDD 105 and performs the noise removal process (noise removal unit 16). The mother substrate 101 extracts the tile area R1 from the temporary tile image X′ generated through the noise removal process to generate the tile image Y (tile image generation unit 17). The mother substrate 101 stores the tile image Y in the HDD 105. The mother substrate 101 transmits the tile image Y generated to a server via a network card 106 when necessary.

<Effect of Image Processing System>

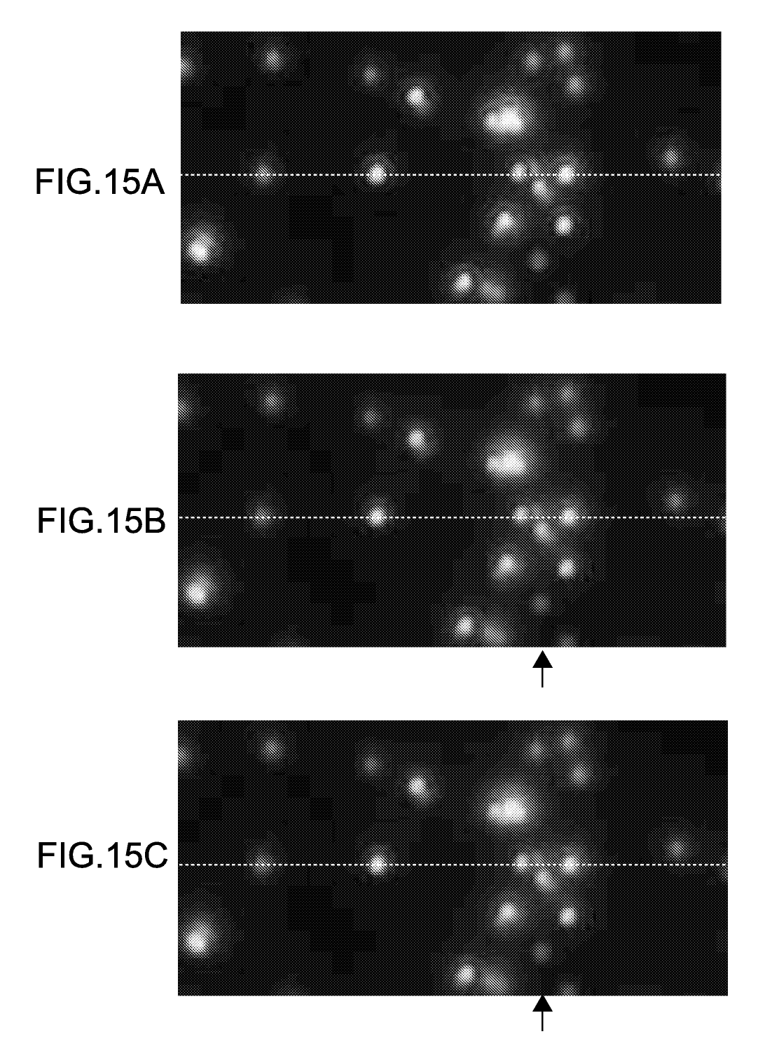

A description will be given on the effect of the image processing system according to this embodiment. FIG. 15 show various images. FIG. 15A is a diagram showing a scan image (200 pixels×100 pixels) which is not subjected to the noise removal process, and FIG. 15B is a diagram showing a tile image (according to the comparative example 2 described above) which has been subjected to the noise removal process after the tiling. FIG. 15C is a diagram showing a tile image which has been subjected to the noise removal process by the image processing system 1 according to this embodiment.

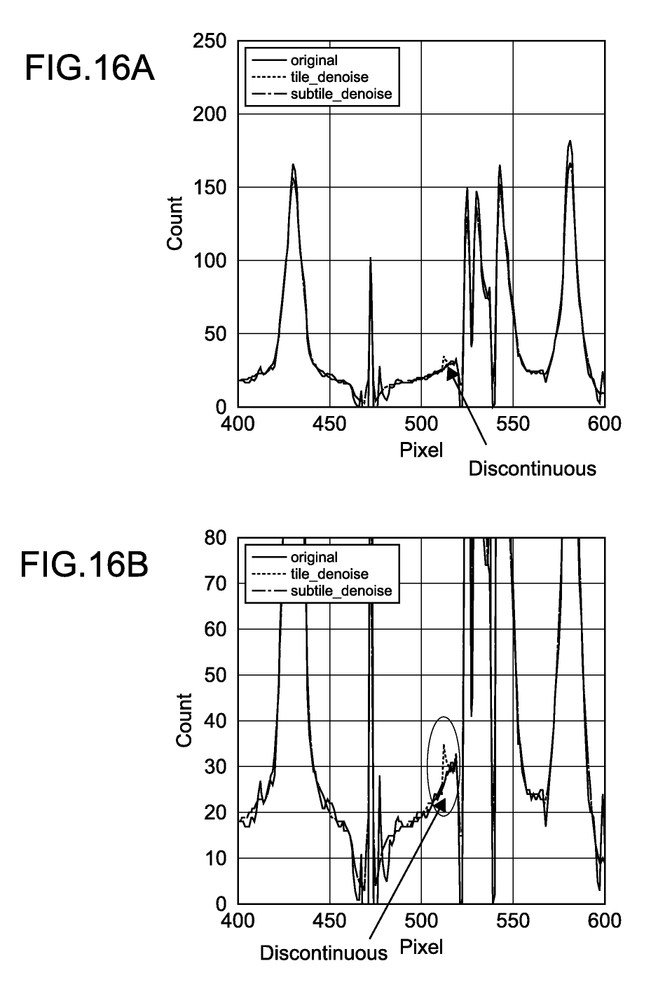

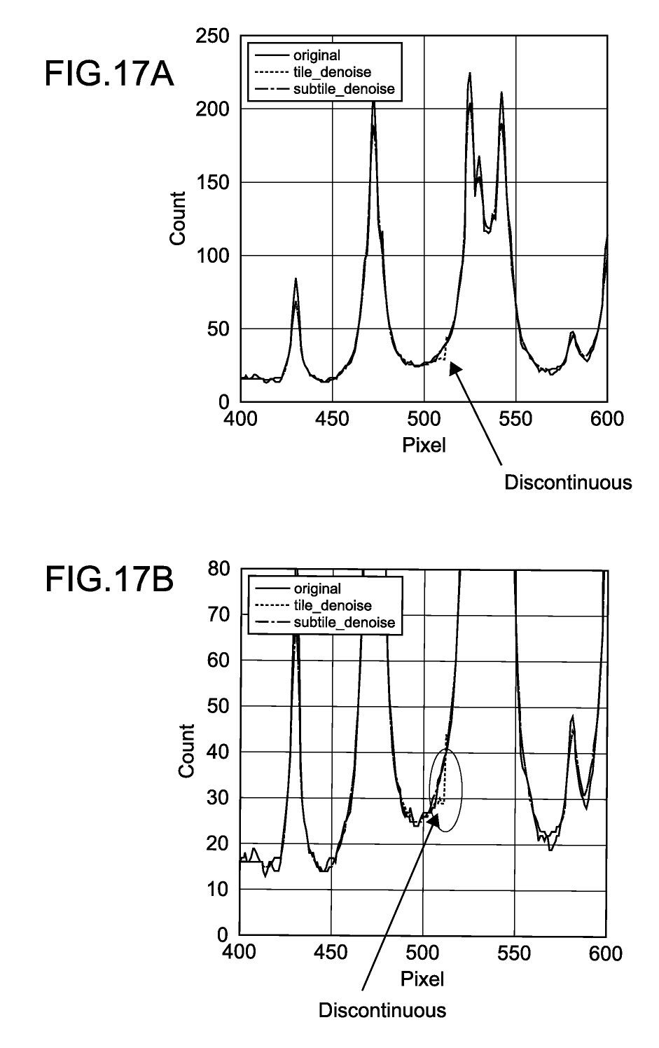

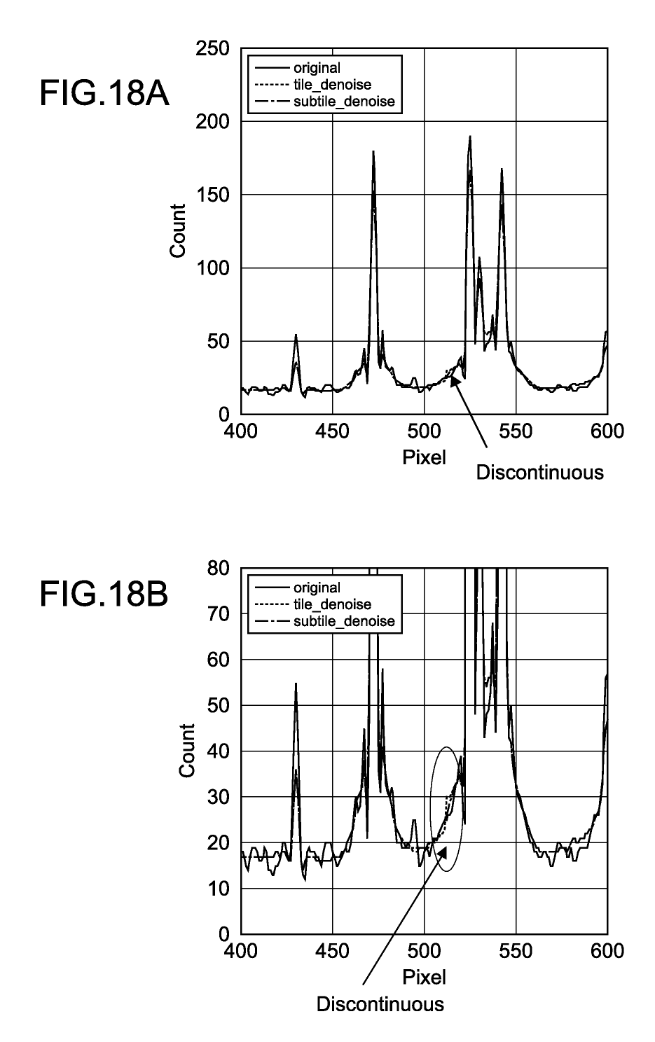

FIGS. 16 to 19 are graphs showing brightness distributions in the images shown in FIGS. 15A to 15C, respectively. FIGS. 16 to 19 each show the brightness distribution on a line (shown as white broken line in each of FIGS. 15A to 15C) perpendicular to a seam of the tiles (except FIG. 15A) of the images shown in each of FIGS. 15A to 15C. FIG. 16, FIG. 17, and FIG. 18 show the brightness distribution relating to red (R), green (G), and blue (B), respectively. It should be noted that FIG. 16B, FIG. 17B, and FIG. 18B are graphs obtained by enlarging the longitudinal axes of the FIG. 16A, FIG. 17A, and FIG. 18A, respectively.

Plots of FIGS. 16 to 18 indicate “before noise removal process (original) (corresponding to FIG. 15A)”, “noise removal after tiling (tile denoising) (corresponding to FIG. 15B)”, and “noise removal according to this embodiment (subtile denoising) (corresponding to FIG. 15C)”, respectively.

As shown in FIGS. 16 to 18, the plot of the “noise removal after tiling (tile denoising)” is discontinuous on a boundary of the tiles as compared to the “before noise removal process (original)”. In contrast, the plot of the “noise removal according to this embodiment (subtile denoising)” is not discontinuous, and the plot similar to the “before noise removal (original)” is obtained.

Thus, from those plots, it is found that, as compared to the scan image before the noise removal process shown in FIG. 15A, in the tile image that has been subjected to the noise removal process after the tiling shown in FIG. 15B, the “seam” (indicated by the arrow in the figures) due to the discontinuous area is generated on the boundary on which the tiles are coupled. In contrast, in the tile image shown in FIG. 15C, the seam is not generated. That is, the image processing system 1 according to this embodiment prevents the discontinuous area from being generated and makes it possible to obtain the tile images with high accuracy.

As described above, the microscope image processing system according to this embodiment quickly releases the memory by generating the temporary tile image. Further, the image processing system generates the tile image in the temporary tile image which has been subjected to the noise removal process except the edge portion in which the discontinuous area may be generated, thereby generating the tile image, on the boundary of which the discontinuous area does not exist. Thus, by the microscope image processing system according to this embodiment, it is possible to generate the microscope image with high accuracy at high speed.

The present disclosure is not limited to the above embodiment, and can be changed without departing from the gist of the present disclosure.

It should be noted that the present disclosure can take the following configurations.

(1) An image processing apparatus, including:

an image obtaining unit configured to obtain a scan image;

a tile area setting unit configured to section the scan image into a plurality of tile areas;

a temporary tile area setting unit configured to set a temporary tile area in the scan image, the temporary tile area including the tile area and being larger than the tile area;

a temporary tile image generation unit configured to extract the scan image for each temporary tile area to generate a temporary tile image;

a noise removal unit configured to perform a noise removal process with respect to the temporary tile image; and

a tile image generation unit configured to extract the temporary tile image for each tile area to generate a tile image.

(2) The image processing apparatus according to Item (1), in which

the image obtaining unit obtains a plurality of continuous scan images,

the image processing apparatus further including

a stitching unit configured to calculate relative positions of the plurality of scan images, and in which

the tile area setting unit sections the scan image into a plurality of tile areas on the basis of the relative positions.

(3) The image processing apparatus according to Item (1) or (2), in which

the scan image is a fluorescence microscope image taken through a fluorescence microscope.

(4) An image processing system, including:

an image pickup apparatus configured to take a scan image of an object to be observed; and

an image processing apparatus including an image obtaining unit configured to obtain the scan image, a tile area setting unit configured to section the scan image into a plurality of tile areas, a temporary tile area setting unit configured to set a temporary tile area in the scan image, the temporary tile area including the tile area and being larger than the tile area, a temporary tile image generation unit configured to extract the scan image for each temporary tile area to generate a temporary tile image, a noise removal unit configured to perform a noise removal process with respect to the temporary tile image, and a tile image generation unit configured to extract the temporary tile image for each tile area to generate a tile image.

(5) The image processing system according to Item (4), in which

the image pickup apparatus takes an image of the object to be observed through a fluorescence microscope.

(6) An image processing program causing a computer to function as:

an image obtaining unit configured to obtain a scan image;

a tile area setting unit configured to section the scan image into a plurality of tile areas;

a temporary tile area setting unit configured to set a temporary tile area in the scan image, the temporary tile area including the tile area and being larger than the tile area;

a temporary tile image generation unit configured to extract the scan image for each temporary tile area to generate a temporary tile image;

a noise removal unit configured to perform a noise removal process with respect to the temporary tile image; and

a tile image generation unit configured to extract the temporary tile image for each tile area to generate a tile image.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An image processing apparatus, comprising:
an image obtaining unit configured to obtain a scan image;
a tile area setting unit configured to section the scan image into a plurality of tile areas;
a temporary tile area setting unit configured to set a temporary tile area in the scan image, the temporary tile area including the tile area and being larger than the tile area;
a temporary tile image generation unit configured to extract the scan image for each temporary tile area to generate a temporary tile image;
a noise removal unit configured to perform a noise removal process with respect to the temporary tile image; and
a tile image generation unit configured to extract the temporary tile image for each tile area to generate a tile image.

2. The image processing apparatus according to claim 1, wherein
the image obtaining unit obtains a plurality of continuous scan images,
the image processing apparatus further comprising
a stitching unit configured to calculate relative positions of the plurality of scan images, and wherein
the tile area setting unit sections the scan image into a plurality of tile areas on the basis of the relative positions.

3. The image processing apparatus according to claim 1, wherein
the scan image is a fluorescence microscope image taken through a fluorescence microscope.

4. An image processing system, comprising:
an image pickup apparatus configured to take a scan image of an object to be observed; and
an image processing apparatus including an image obtaining unit configured to obtain the scan image, a tile area setting unit configured to section the scan image into a plurality of tile areas, a temporary tile area setting unit configured to set a temporary tile area in the scan image, the temporary tile area including the tile area and being larger than the tile area, a temporary tile image generation unit configured to extract the scan image for each temporary tile area to generate a temporary tile image, a noise removal unit configured to perform a noise removal process with respect to the temporary tile image, and a tile image generation unit configured to extract the temporary tile image for each tile area to generate a tile image.

5. The image processing system according to claim 4, wherein
the image pickup apparatus takes an image of the object to be observed through a fluorescence microscope.

6. An image processing program causing a computer to function as:
an image obtaining unit configured to obtain a scan image;
a tile area setting unit configured to section the scan image into a plurality of tile areas;
a temporary tile area setting unit configured to set a temporary tile area in the scan image, the temporary tile area including the tile area and being larger than the tile area;
a temporary tile image generation unit configured to extract the scan image for each temporary tile area to generate a temporary tile image;
a noise removal unit configured to perform a noise removal process with respect to the temporary tile image; and
a tile image generation unit configured to extract the temporary tile image for each tile area to generate a tile image.
